(19) United States
(12) Patent Application Publication
(10) Pub. No.: US 2021/0042060 A1
(43) Pub. Date: Feb. 11, 2021

(54) STORAGE DEVICE AND OPERATING METHOD THEREOF

(71) Applicant: SK hynix Inc., Icheon (KR)

(72) Inventor: Byung Jun KIM, Seoul (KR)

(21) Appl. No.: 16/696,397

(22) Filed: Nov. 26, 2019

(30) Foreign Application Priority Data
Aug. 9, 2019 (KR) 10-2019-0097806

(51) Int. Cl. G06F 3/06

(52) U.S. Cl. CPC G06F 3/0659; G06F 3/061; G06F 3/0679

(57) ABSTRACT

A memory controller having improved command scheduling performance controls a memory device. The memory controller includes a command queue and a command queue controller. The command queue stores a plurality of commands corresponding to a plurality of operation requests from a host, and outputs the plurality of commands to the memory device. The command queue controller controls the command queue to preferentially output, to the memory device, at least one target command corresponding to an urgent processing request from the host among the plurality of command, in response to the urgent processing request.

### CROSS-REFERENCE TO RELATED APPLICATION

The present application claims priority under 35 U.S.C. § 119(a) to Korean Patent Application Number 10-2019-0097806, filed on Aug. 9, 2019, in the Korean Intellectual Property Office, the entire disclosure of which is incorporated herein by reference.

### BACKGROUND

### 1. Technical Field

Embodiments of the present disclosure generally relate to an electronic device, and more particularly, to a storage device and an operating method thereof.

### 2. Related Art

A storage device stores data under the control of a host device such as a computer or a smart phone. The storage device may include a memory device for storing data and a memory controller for controlling the memory device. The memory device may include a volatile memory device, a nonvolatile memory device, or both.

A volatile memory device stores data only when power is supplied thereto, and loses stored data when the supply of power is interrupted. The volatile memory device may include a Static Random Access Memory (SRAM), a Dynamic Random Access Memory (DRAM), or the like.

A nonvolatile memory device does not lose data stored therein even when the supply of power is interrupted. The nonvolatile memory device may include a Read Only Memory (ROM), a Programmable ROM (PROM), an Electrically Programmable ROM (EPROM), an Electrically Erasable ROM (EEROM), a flash memory, or the like.

### SUMMARY

Embodiments provide a storage device having improved command scheduling performance and an operating method thereof.

In accordance with an aspect of the present disclosure, there is provided a memory controller for controlling a memory device, the memory controller including: a command queue configured to store a plurality of commands corresponding to a plurality of operation requests from a host, and output the plurality of commands to the memory device; and a command queue controller configured to control the command queue to preferentially output, to the memory device, at least one target command corresponding to an urgent processing request from the host among the plurality of command, in response to the urgent processing request.

In accordance with another aspect of the present disclosure, there is provided a method for operating a memory controller that controls a memory device and includes a command queue, the method including: storing, in the command queue, a plurality of commands corresponding to a plurality of operation requests from a host; receiving an urgent processing request from the host; and scheduling a sequence in which the plurality of commands are output to the memory device such that at least one target command corresponding to the urgent processing request among the plurality of commands is preferentially output to the memory device.

In accordance with still another aspect of the present disclosure, there is provided a memory controller for controlling a memory device, the memory controller including: a main queue configured to store a plurality of commands corresponding to a plurality of operation requests from a host; an urgent queue configured to store a command to be output to the memory device more preferentially than the commands stored in the main queue; and a command queue controller configured to move, from the main queue to the urgent queue, at least one target command corresponding to an urgent processing request from the host, in response to the urgent processing request.

### BRIEF DESCRIPTION OF THE DRAWINGS

Example embodiments will now be described more fully hereinafter with reference to the accompanying drawings.

FIG. 1 illustrates a storage device in accordance with an embodiment of the present disclosure.

FIG. 2 illustrates a memory device shown in FIG. 1 in accordance with an embodiment of the present disclosure.

FIG. 3 illustrates a memory cell array shown in FIG. 2 in accordance with an embodiment of the present disclosure.

FIG. 4 illustrates a logical unit in accordance with an embodiment of the present disclosure.

FIG. 5 illustrates a configuration and an operation of a memory controller in accordance with an embodiment of the present disclosure.

FIG. 6 illustrates a command scheduling operation shown in FIG. 5 in accordance with an embodiment of the present disclosure.

FIG. 7 illustrates the command scheduling operation shown in FIG. 5 in accordance with another embodiment of the present disclosure.

FIG. 8 illustrates the command scheduling operation shown in FIG. 5 in accordance with still another embodiment of the present disclosure.

FIG. 9 illustrates the command scheduling operation shown in FIG. 5 in accordance with still another embodiment of the present disclosure.

FIG. 10 is a flowchart illustrating an operation of the memory controller shown in FIG. 5 in accordance with an embodiment of the present disclosure.

FIG. 11 illustrates a configuration and an operation of a memory controller in accordance with another embodiment of the present disclosure.

FIG. 12 illustrates a command scheduling operation shown in FIG. 11 in accordance with an embodiment of the present disclosure.

FIG. 13 is a flowchart illustrating an operation of the memory controller shown in FIG. 11 in accordance with an embodiment of the present disclosure.

FIG. 14 illustrates a memory controller in accordance with an embodiment of the present disclosure.

FIG. 15 illustrates a memory card system in accordance with an embodiment of the present disclosure.

FIG. 16 illustrates a Solid State Drive (SSD) system in accordance with an embodiment of the present disclosure.

FIG. 17 illustrates a user system in accordance with an embodiment of the present disclosure.

### DETAILED DESCRIPTION

The specific structural or functional description disclosed herein is merely illustrative for the purpose of describing embodiments according to the inventive concept of the present disclosure. The embodiments according to the inventive concept of the present disclosure can be implemented in various forms, and cannot be construed as limited to the embodiments set forth herein.

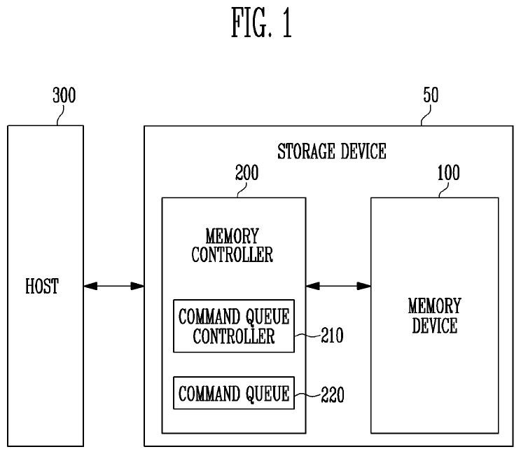

FIG. 1 illustrates a storage device 50 in accordance with an embodiment of the present disclosure.

Referring to FIG. 1, the storage device 50 may include a memory device 100 and a memory controller 200 configured to control an operation of the memory device 100. The storage device 50 may store data under the control of a host 300 such as a mobile phone, a smart phone, an MP3 player, a laptop computer, a desktop computer, a game console, a TV, a tablet PC, an in-vehicle infotainment device, or the like.

The storage device 50 may be one of various types of storage devices according to a host interface that is a communication scheme with the host 300. For example, the storage device 50 may be any one of a Solid State Drive (SSD), a Multi-Media Card (MMC), an Embedded MMC (eMMC), a Reduced Size MMC (RS-MMC), a micro-MMC (micro-MMC), a Secure Digital (SD) card, a mini-SD card, a micro-SD card, a Universal Serial Bus (USB) storage device, a Universal Flash Storage (UFS) device, a Compact Flash (CF) card, a Smart Media Card (SMC), a memory stick, and so on.

The storage device 50 may be manufactured to have one of various kinds of package types. For example, the storage device 50 may be manufactured to be any one of a Package-On-Package (POP), a System-In-Package (SIP), a System-On-Chip (SOC), a Multi-Chip Package (MCP), a Chip-On-Board (COB), a Wafer-level Fabricated Package (WFP), a Wafer-level Stack Package (WSP), and so on.

The memory device 100 may store data. The memory device 100 operates under the control of the memory controller 200. The memory device 100 may include a memory cell array including a plurality of memory cells for storing data.

Each of the memory cells may be a Single Level Cell (SLC) storing one bit of data, a Multi-Level Cell (MLC) storing two bits of data, a Triple Level Cell (TLC) storing three bits of data, or a Quad Level Cell (QLC) storing four bits of data.

The memory cell array may include a plurality of memory blocks. Each memory block may include a plurality of memory cells. A memory block may be a unit for erasing data stored in the memory device 100. A memory block may include a plurality of pages. A page may be a unit for writing or programming data in the memory device 100 or reading data stored in the memory device 100. A page may include a multiplicity of memory cells coupled to the same word line.

In an embodiment, the memory device 100 may be a Double Data Rate Synchronous Dynamic Random Access Memory (DDR SDRAM), a Low Power Double Data Rate 4 (LPDDR4) SDRAM, a Graphics Double Data Rate (GDDR) SRAM, a Low Power DDR (LPDDR), a Rambus Dynamic Random Access Memory (RDRAM), a NAND flash memory, a vertical NAND flash memory, a NOR flash memory, a Resistive Random Access Memory (RRAM), a Phase-Change Random Access Memory (PRAM), a Magnetoresistive Random Access Memory (MRAM), a Ferroelectric Random Access Memory (FRAM), a Spin Transfer Torque Random Access Memory (STT-RAM), or the like. In this specification, for convenience of description, it is assumed that the memory device 100 is a NAND flash memory.

The memory device 100 receives a command and an address from the memory controller 200 and accesses an area selected by the address in the memory cell array. That is, the memory device 100 may perform an operation instructed by the command on the area selected by the address. For example, the memory device 100 may perform a write (or program) operation, a read operation, and an erase operation. In the program operation, the memory device 100 may program data in the area selected by the address. In the read operation, the memory device 100 may read data stored in the area selected by the address. In the erase operation, the memory device 100 may erase data stored in the area selected by the address.

The memory controller 200 may control all operations of the storage device 50.

When power is supplied to the storage device 50, the memory controller 200 may execute firmware (FW). When the memory device 100 is a flash memory device such as a NAND flash memory, the memory controller 200 may execute FW such as a Flash Translation Layer (FTL) for controlling communication between the host 300 and the memory device 100.

In an embodiment, the memory controller 200 may receive write data and a Logical Block Address (LBA) from the host 300, and translate the LBA into a Physical Block Address (PBA) indicating a storage area of the memory device 100 in which the write data is to be stored.

The memory controller 200 may control the memory device 100 to perform a program operation, a read operation, an erase operation, or the like in response to a request from the host 300. In the program operation, the memory controller 200 may provide a write command, a PBA, and write data to the memory device 100. In the read operation, the memory controller 200 may provide a read command and a PBA to the memory device 100. In the erase operation, the memory controller 200 may provide an erase command and a PBA to the memory device 100.

In an embodiment, the memory controller 200 may autonomously generate a command, an address, and data regardless of a request from the host 300, and transmit the command, the address, and the data to the memory device 100. For example, the memory controller 200 may provide the command, the address, and the data to the memory device 100 to perform background operations such as a program operation for wear leveling and a program operation for garbage collection.

In an embodiment, the memory controller 200 may control two or more memory devices 100. The memory controller 200 may control the two or more memory devices according to an interleaving scheme so as to improve operational performance. The interleaving scheme may be an operating scheme that allows operating sections of the two or more memory devices 100 to overlap each other.

In an embodiment, the memory controller 200 may include a command queue controller 210 and a command queue 220.

The command queue controller 210 may generate a command corresponding to an operation request received from the host 300 in response to the operation request. The command queue controller 210 may store the command in the command queue 220. The operation request may be any of a write request, a read request, an erase request, an unmap request, and so on.

In an embodiment, the command queue controller 210 may sequentially generate a plurality of commands corresponding to a plurality of operation requests from the host 300 in response to the plurality of operation requests. The command queue controller 210 may sequentially store the plurality of commands in the command queue 220 in a sequence of generating the plurality of commands.

The command queue controller 210 may schedule a sequence of outputting the plurality of commands stored in the command queue 220 to the memory device 100. For example, the command queue controller 210 may internally schedule the sequence of outputting the plurality of commands to the memory device 100 according to an operational environment of the memory device 100. The command queue controller 210 may schedule the sequence of outputting the plurality of commands to the memory device 100 in response to an urgent processing request provided by the host 300.

In other words, the command queue controller 210 may control the command queue 220 such that at least one target command corresponding to the urgent processing request, among the plurality of commands stored in the command queue 220, is preferentially output to the memory device 100.

Specifically, the command queue controller 210 may select at least one target command among the plurality of commands stored in the command queue 220 based on urgent processing information included in the urgent processing request.

The urgent processing information may include one or more of command type information, command ID information, and logical address information, which correspond to the at least one target command. The command type information may indicate a type of the target command, such as any one of a read command, a write command, an erase command, an unmap command, and so on. The command ID information may include a unique ID of the target command. The logical address information may include a logical address corresponding to an area in which an operation corresponding to the target command is to be performed.

The command queue controller 210 may control the command queue 220 such that the at least one target command selected from the plurality of commands is output to the memory device 100 more preferentially than the other commands. That is, the at least one target command is output to the memory device 100 before the other commands are output to the memory device 100.

The command queue 220 may store the plurality of commands corresponding to the plurality of operation requests from the host 300. Since the command queue 220 basically uses a First-In-First-Out (FIFO) scheme, the command queue 220 may output commands to the memory device 100 in a sequence in which the commands are input to the command queue 220. The sequence of outputting the plurality of commands stored in the command queue 220 to the memory device 100 may be changed under the control of the command queue controller 210.

As described above, the at least one target command corresponding to the urgent processing request among the plurality of commands stored in the command queue 220 may be output to the memory device 100 more preferentially than the other commands.

The host 300 may communicate with the storage device 50 using at least one of various communication protocols such as a Universal Serial bus (USB), a Serial AT Attachment (SATA), a High Speed InterChip (HSIC), a Small Computer System Interface (SCSI), Firewire, a Peripheral Component Interconnection (PCI), a PCI express (PCIe), a Non-Volatile Memory express (NVMe), a universal flash storage (UFS), a Secure Digital (SD), a Multi-Media Card (MMC), an embedded MMC (eMMC), a Dual In-line Memory Module (DIMM), a Registered DIMM (RDIMM), a Load Reduced DIMM (LRDIMM), and so on.

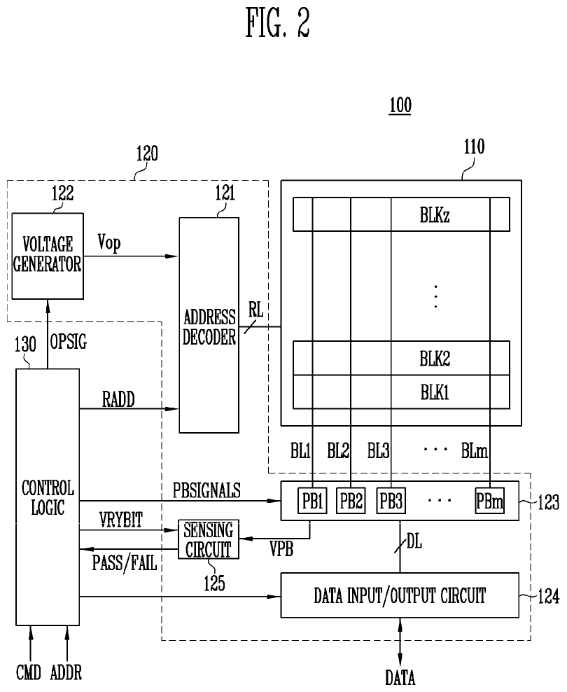

FIG. 2 illustrates the memory device 100 shown in FIG. 1 in accordance with an embodiment of the present disclosure.

Referring to FIG. 2, the memory device 100 may include a memory cell array 110, a peripheral circuit 120, and a control logic 130.

The memory cell array 110 includes a plurality of memory blocks BLK1 to BLKz. The plurality of memory blocks BLK1 to BLKz are coupled to an address decoder 121 through row lines RL. The plurality of memory blocks BLK1 to BLKz are coupled to a read/write circuit 123 through bit lines BL1 to BLm.

Each of the plurality of memory blocks BLK1 to BLKz includes a plurality of memory cells. In an embodiment, the plurality of memory cells may be nonvolatile memory cells. Memory cells coupled to the same word line among the plurality of memory cells may be defined as one physical page. Therefore, the memory cell array 110 may be configured with a plurality of physical pages.

In accordance with an embodiment of the present disclosure, each of the plurality of memory blocks BLK1 to BLKz included in the memory cell array 110 may further include a plurality of dummy cells. A first dummy cell group including one or more dummy cells coupled in series may be coupled to and disposed between a drain select transistor and memory cells, and a second dummy cell group including one or more dummy cells coupled in series may be coupled to and disposed between a source select transistor and the memory cells.

Each of the memory cells of the memory device 100 may be configured as a Single Level Cell (SLC) storing one bit of data, a Multi-Level Cell (MLC) storing two bits of data, a Triple Level Cell (TLC) storing three bits of data, or a Quad Level Cell (QLC) storing four bits of data.

The peripheral circuit 120 may include the address decoder 121, a voltage generator 122, the read/write circuit 123, a data input/output circuit 124, and a sensing circuit 125.

The peripheral circuit 120 drives the memory cell array 110. For example, the peripheral circuit 120 may drive the memory cell array 110 to perform a program operation, a read operation, and an erase operation.

The address decoder 121 is coupled to the memory cell array 110 through the row lines RL. The row lines RL may include drain select lines, word lines, source select lines, and a common source line. In accordance with an embodiment of the present disclosure, the word lines may include normal word lines coupled to memory cells and dummy word lines coupled to dummy cells. In accordance with an embodiment of the present disclosure, the row lines RL may further include a pipe select line.

In an embodiment, the row lines RL may be local lines included in local line groups. Each local line group may correspond to one memory block. The local line group may include a drain select line, local word lines, and a source select line.

The address decoder 121 may operate under the control of the control logic 130. The address decoder 121 receives an address RADD from the control logic 130.

The address decoder 121 may decode a block address included in the received address RADD. The address decoder 121 selects at least one memory block among the memory blocks BLK1 to BLKz according to the decoded block address. The address decoder 121 may decode the address RADD. The address decoder 121 may select at least one word line coupled to the selected memory block by applying voltages provided from the voltage generator 122 to word lines coupled to the selected memory block according to the decoded address RADD.

In a program operation, the address decoder 121 may apply a program voltage to the selected word line, and apply a pass voltage having a lower level than the program voltage to unselected word lines, among the word lines coupled to the selected memory block. In a program verify operation following the program operation, the address decoder 121 may apply a verify voltage to the selected word line, and apply a verify pass voltage having a higher level than the verify voltage to the unselected word lines.

In a read operation, the address decoder 121 may apply a read voltage to the selected word line, and apply a read pass voltage having a higher level than the read voltage to the unselected word lines, among the word lines coupled to the selected memory block.

In accordance with an embodiment of the present disclosure, an erase operation of the memory device 100 is performed in units of memory blocks. In the erase operation, an address ADDR input to the memory device 100 includes a block address. The address decoder 121 may decode the block address and select one memory block according to the decoded block address. In the erase operation, the address decoder 121 may apply a ground voltage to word lines coupled to the selected memory block.

In accordance with an embodiment of the present disclosure, the address decoder 121 may decode a column address included in the address RADD. The decoded column address may be transmitted to the read/write circuit 123. In an example, the address decoder 121 may include a row decoder, a column decoder, and an address buffer.

In an embodiment, the voltage generator 122 may generate a plurality of operating voltages Vop by using an external power voltage supplied to the memory device 100. The voltage generator 122 operates under the control of the control logic 130. The voltage generator 122 may generate an internal power voltage by regulating the external power voltage. The internal power voltage generated by the voltage generator 122 is used as an operation voltage of the memory device 100.

In another embodiment, the voltage generator 122 may generate the plurality of operating voltages Vop by using the internal power voltage.

The voltage generator 122 may generate various voltages required by the memory device 100. For example, the voltage generator 122 may generate a plurality of erase voltages, a plurality of program voltages, a plurality of pass voltages, a plurality of select read voltages, a plurality of unselect read voltages, and so on.

In order to generate the plurality of operating voltages Vop having various voltage levels, the voltage generator 122 may include a plurality of pumping capacitors for receiving the internal power voltage, and generate the plurality of operating voltages Vop by selectively activating the plurality of pumping capacitors under the control of the control logic 130.

The plurality of operating voltages Vop may be supplied to the memory cell array 110 by the address decoder 121.

The read/write circuit 123 includes first to mth page buffers PB1 to PBm. The first to mth page buffers PB1 to PBm are coupled to the memory cell array 110 through the respective first to mth bit lines BL1 to BLm. The first to mth page buffers PB1 to PBm operate under the control of the control logic 130.

The first to mth page buffers PB1 to PBm communicate data DATA with the data input/output circuit 124. In the program operation, the first to mth page buffers PB1 to PBm receive data DATA to be stored in the memory cell array 110 through the data input/output circuit 124 and data lines DL.

In the program operation, the first to mth page buffers PB1 to PBm may transfer, to selected memory cells through the bit lines BL1 to BLm, the data DATA received through the data input/output circuit 124 when a program pulse is applied to a selected word line. The selected memory cells are programmed with the data DATA. A memory cell coupled to a bit line through which a program allow voltage (e.g., a ground voltage) is applied may have an increased threshold voltage. A threshold voltage of a memory cell coupled to a bit line through which a program inhibit voltage (e.g., a power voltage) is applied may be maintained its original level without being increased. In a program verify operation, the first to mth page buffers PB1 to PBm read the data DATA stored in the selected memory cells through the bit lines BL1 to BLm.

In a read operation, the read/write circuit 123 may read data DATA from memory cells of a selected page through the bit lines BL1 to BLm, and store the read data DATA in the first to mth page buffers PB1 to PBm.

In an erase operation, the read/write circuit 123 may float the bit lines BL1 to BLm. In an embodiment, the read/write circuit 123 may include a column select circuit.

The data input/output circuit 124 is coupled to the first to mth page buffers PB1 to PBm through the data lines DL. The data input/output circuit 124 operates under the control of the control logic 130.

The data input/output circuit 124 may include a plurality of input/output buffers (not shown) that receive data DATA from the memory cell array 110 or from an external device (not shown), e.g., the memory controller 200 of FIG. 1. In the program operation, the data input/output circuit 124 may receive data DATA to be stored from the external controller. In the read operation, the data input/output circuit 124 outputs, to the external controller, data DATA transmitted from the memory cell array 110 through the first to mth page buffers PB1 to PBm included in the read/write circuit 123.

In the read operation or the program verify operation, the sensing circuit 125 may generate a reference current in response to an allow bit signal VRYBIT generated by the control logic 130, and output a pass signal PASS or a fail signal FAIL to the control logic 130 by comparing a sensing voltage VPB received from the read/write circuit 123 and a reference voltage generated by the reference current.

The control logic 130 may be coupled to the address decoder 121, the voltage generator 122, the read/write circuit 123, the data input/output circuit 124, and the sensing circuit 125. The control logic 130 may control all operations of the memory device 100. The control logic 130 may operate in response to a command CMD transferred from an external device, e.g., the memory controller 200 of FIG. 1.

The control logic 130 may control the peripheral circuit 120 by generating several signals in response to the command CMD and the address ADDR. For example, the control logic 130 may generate an operation signal OPSIG, the address RADD, a read/write circuit control signal PBSIGNALS, and the allow bit signal VRYBIT in response to the command CMD and the address ADDR. The control logic 130 may output the operation signal OPSIG to the voltage generator 122, output the address RADD to the address decoder 121, output the read/write circuit control signal PBSIGNALS to the read/write circuit 123, and output the allow bit signal VRYBIT to the sensing circuit 125. Also, the control logic 130 may determine whether the program verify operation has passed or failed in response to the pass or fail signal PASS/FAIL output by the sensing circuit 125.

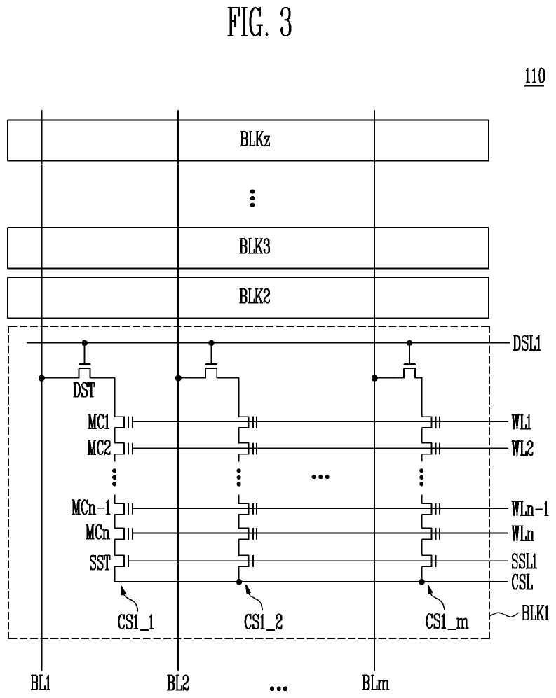

FIG. 3 illustrates the memory cell array 110 shown in FIG. 2 in accordance with an embodiment of the present disclosure.

Referring to FIG. 3, the first to zth memory blocks BLK1 to BLKz in the memory cell array 110 are commonly coupled to the first to mth bit lines BL1 to BLm. In FIG. 3, for convenience of description, components included in the first memory block BLK1 among the first to zth memory blocks BLK1 to BLKz are illustrated. Components included in each of the other memory blocks BLK2 to BLKz are omitted since each of the other memory blocks BLK2 to BLKz is configured identically to the first memory block BLK1.

The memory block BLK1 may include a plurality of cell strings CS1_1 to CS1_m (m is a positive integer). The first to mth cell strings CS1_1 to CS1_m are respectively coupled to the first to mth bit lines BL1 to BLm. Each of the first to mth cell strings CS1_1 to CS1_m includes a drain select transistor DST, a plurality of memory cells MC1 to MCn (n is a positive integer) coupled in series, and a source select transistor SST.

A gate terminal of the drain select transistor DST included in each of the first to mth cell strings CS1_1 to CS1_m is coupled to a drain select line DSL1. Gate terminals of the first to nth memory cells MC1 to MCn included in each of the first to mth cell strings CS1_1 to CS1_m are respectively coupled to first to nth word lines WL1 to WLn. A gate terminal of the source select transistor SST included in each of the first to mth cell strings CS1_1 to CS1_m is coupled to a source select line SSL1.

For convenience of description, a structure of a cell string will be described based on the first cell string CS1_1 among the plurality of cell strings CS1_1 to CS1_m. However, it will be understood that each of the other cell strings CS1_2 to CS1_m is configured identically to the first cell string CS1_1.

A drain terminal of the drain select transistor DST included in the first cell string CS1_1 is coupled to the first bit line BL1. A source terminal of the drain select transistor DST included in the first cell string CS1_1 is coupled to a drain terminal of the first memory cell MC1 included in the first cell string CS1_1. The first to nth memory cells MC1 to MCn are coupled in series to each other. A drain terminal of the source select transistor SST included in the first cell string CS1_1 is coupled to a source terminal of the nth memory cell MCn included in the first cell string CS1_1. A source terminal of the source select transistor SST included in the first cell string CS1_1 is coupled to a common source line CSL. In an embodiment, the common source line CSL may be commonly coupled to the plurality of cell strings CS1_1 to CS1_m. In addition, in an embodiment, the common source line CSL may be commonly coupled to at least one of the first to zth memory blocks BLK1 to BLKz.

The drain select line DSL1, the first to nth word lines WL1 to WLn, and the source select line SSL1 are included in the row lines RL shown in FIG. 2. The drain select line DSL1, the first to nth word lines WL1 to WLn, and the source select line SSL1 are controlled by the address decoder 121 shown in FIG. 2. The common source line CSL may be controlled by the control logic 130 shown in FIG. 2. The first to mth bit lines BL1 to BLm are controlled by the read/write circuit 123 shown in FIG. 2.

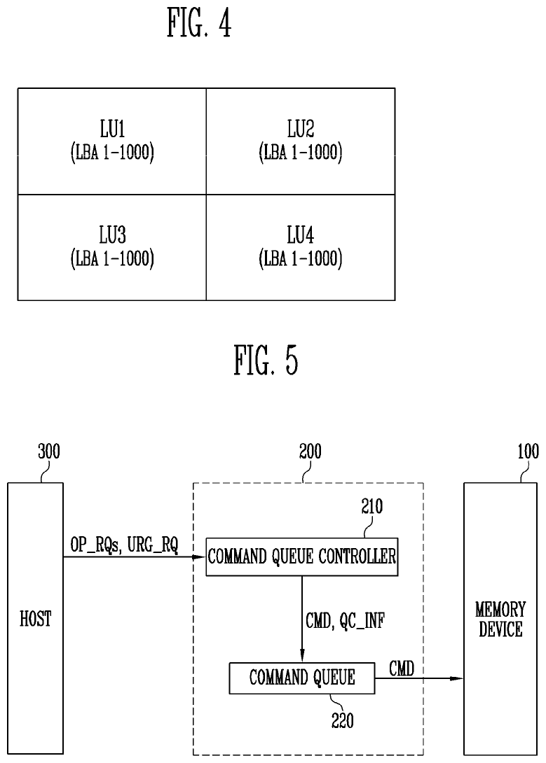

FIG. 4 illustrates a logical unit in accordance with an embodiment of the present disclosure.

Referring to FIG. 4, a storage area of the memory device 100 described above with reference to FIG. 1 may be divided into a plurality of logical units LU. A size of a logical unit LU may be differently set depending on a request from the host 300 of FIG. 1. The storage area may be divided into one or more logical units respectively corresponding to a plurality of logical block addresses (LBAs). In an embodiment, the storage area may include a storage area of at least one memory device.

In FIG. 4, the storage area of the memory device 100 may be divided into first to fourth logical units LU1 to LU4. Logical addresses LBA1 to LBA1000 may be individually allocated to each of the first to fourth logical units LU1 to LU4. A partial area in the storage area of the memory device 100 may be specified by a logical unit and a logical address.

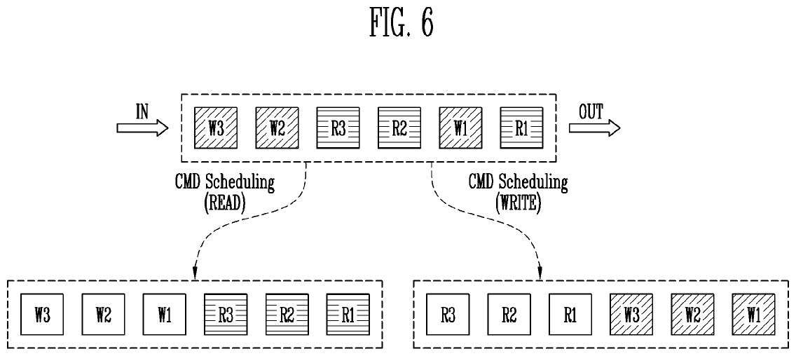

FIG. 5 illustrates a configuration and an operation of the memory controller 200 of FIG. 1 in accordance with an embodiment of the present disclosure.

Referring to FIG. 5, the memory controller 200 may include the command queue controller 210 and the command queue 220 as illustrated in FIG. 1.

The command queue controller 210 may generate a command CMD corresponding to an operation request OP_RQ received from the host 300 in response to the operation request OP_RQ. The command queue controller 210 may store the command CMD in the command queue 220. The operation request OP_RQ may be any of a write request, a read request, an erase request, and an unmap request.

In an embodiment, the command queue controller 210 may sequentially generate a plurality of commands CMDs corresponding to a plurality of operation requests OP_RQs from the host 300 in response to the plurality of operation requests OP_RQs. The command queue controller 210 may store the plurality of commands CMDs in the command queue 220 in a sequence of generating the plurality of commands CMDs.

The command queue controller 210 may provide the command queue 220 with command queue control information QC_INF for controlling an operation of the command queue 220. The command queue controller 210 may schedule a sequence of outputting the plurality of commands CMDs stored in the command queue 220 to the memory device 100 using the command queue control information QC_INF.

In an embodiment, the command queue controller 210 may internally schedule the sequence of outputting the plurality of commands CMDs to the memory device 100 according to an operational environment of the memory device 100.

In another embodiment, the command queue controller 210 may schedule the sequence of outputting the plurality of commands CMDs to the memory device 100 in response to an urgent processing request URG_RQ provided by the host 300. In other words, the command queue controller 210 may provide the command queue control information QC_INF to the command queue 220 such that at least one target command corresponding to the urgent processing request URG_RQ among the plurality of commands CMDs stored in the command queue 220 is preferentially output to the memory device 100.

Specifically, the command queue controller 210 may select the at least one target command among the plurality of commands CMDs stored in the command queue 220 based on urgent processing information included in the urgent processing request URG_RQ.

The urgent processing information may include one or more of command type information, command ID information, and logical address information, which correspond to the at least one target command. The command type information may indicate a type of the target command that is any one of a read command, a write command, an erase command, and an unmap command. The command ID information may include a unique ID of the target command. The logical address information may include a logical address corresponding to an area in which an operation corresponding to the target command is to be performed.

The command queue controller 210 may provide the command queue control information QC_INF to the command queue 220 such that the at least one target command selected from the plurality of commands CMDs is output to the memory device 100 more preferentially than the other commands.

The command queue 220 may store the plurality of commands CMDs corresponding to the plurality of operation requests OP_RQs provided by the host 300. Since the command queue 220 basically uses the FIFO scheme, the command queue 220 may output commands to the memory device 100 in a sequence in which the commands are input to the command queue 220. The sequence of outputting the plurality of commands CMDs stored in the command queue 220 to the memory device 100 may be changed under the control of the command queue controller 210.

In an embodiment, the at least one target command corresponding to the urgent processing request URG_RQ among the plurality of commands CMDs stored in the command queue 220 may be output to the memory device 100 more preferentially than the other commands in response to the command queue control information QC_INF.

FIG. 6 illustrates a command scheduling operation shown in FIG. 5 in accordance with an embodiment of the present disclosure.

Referring to FIG. 6, the command queue 220 of FIG. 5 may store a plurality of commands. The number of commands stored in the command queue 220 is not limited to this embodiment. Since the command queue 220 uses the FIFO scheme, the command queue 220 may output commands to the memory device 100 in a sequence in which the commands are input to the command queue 220.

Therefore, when a first read command R1, a first write command W1, a second read command R2, a third read command R3, a second write command W2, and a third write command W3 are sequentially input to the command queue 220, the plurality of commands R1, R2, R3, W1, W2, and W3 stored in the command queue 220 may be output to the memory device 100 in a sequence of the first read command R1, the first write command W1, the second read command R2, the third read command R3, the second write command W2, and the third write command W3, before the command scheduling operation is performed.

The sequence of outputting the plurality of commands R1, R2, R3, W1, W2, and W3 stored in the command queue 220 to the memory device 100 may be scheduled according to the urgent processing information included in the urgent processing request URG_RQ from the host 300. The urgent processing information may include command type information. The command type information may indicate a command type of one of a read command, a read command, an erase command, and an unmap command.

In an example, the command scheduling operation may be performed according to the command type information included in the urgent processing request URG_RQ. The command type information may include a type of the read command.

When the command type information indicates the type of the read command, the read commands R1, R2, and R3 among the plurality of commands R1, R2, R3, W1, W2, and W3 stored in the command queue 220 may be scheduled to be output to the memory device 100 more preferentially than the other commands W1, W2, and W3. A sequence of outputting the commands R1, R2, and R3 to the memory device 100 may be identical to that before the command scheduling operation is performed. Therefore, although the read commands R1, R2, and R3 are output to the memory device 100 more preferentially than the other commands W1, W2, and W3, the commands R1, R2, and R3 may be output to the memory device 100 in a sequence of the first read command R1, the second read command R2, and the third read command R3. In another embodiment, the sequence of outputting the commands R1, R2, and R3 may be changed.

In another example, when the command scheduling operation is performed according to the command type information included in the urgent processing request URG_RQ and the command type information includes the type of the write command, the write commands W1, W2, and W3 among the plurality of commands R1, R2, R3, W1, W2, and W3 stored in the command queue 220 may be scheduled to be output to the memory device 100 more preferentially than the other commands R1, R2, and R3. A sequence in which the commands W1, W2, and W3 are preferentially output to the memory device 100 may be identical to that before the command scheduling operation is performed. That is, the commands W1, W2, and W3 may be output to the memory device 100 in a sequence of the first write command W1, the second write command W2, and the third write command W3. In another embodiment, the sequence of outputting the commands W1, W2, and W3 may be changed.

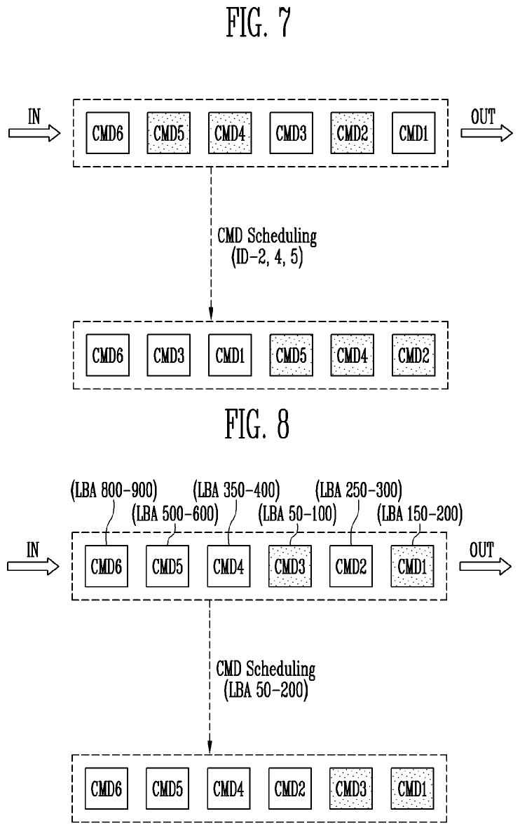

FIG. 7 illustrates the command scheduling operation shown in FIG. 5 in accordance with another embodiment of the present disclosure.

Referring to FIG. 7, before the command scheduling operation is performed, a plurality of commands CMDs stored in the command queue 220 may be output to the memory device 100 in a sequence of a first command CMD1, a second command CMD2, a third command CMD3, a fourth command CMD4, a fifth command CMD5, and a sixth command CMD6.

A sequence in which the plurality of commands CMDs stored in the command queue 220 are output to the memory device 100 may be scheduled based on urgent processing information included in an urgent processing request URG_RQ from the host 300. The urgent processing information may include command ID information. The command ID information may include a unique ID of at least one target command to be preferentially output to the memory device 100 among the plurality of commands CMDs.

For example, the command scheduling operation may be performed based on the command ID information included in the urgent processing request URG_RQ. The command ID information may include IDs of the second command CMD2, the fourth command CMD4, and the fifth command CMD5.

The second command CMD2, the fourth command CMD4, and the fifth command CMD5 among the plurality of commands CMDs stored in the command queue 220 may be scheduled to be output to the memory device 100 more preferentially than the other commands CMD1, CMD3, and

CMD6. A sequence of the commands CMD2, CMD4, and CMD5 preferentially output to the memory device 100 may be identical to that before the command scheduling operation is performed.

Therefore, although the second command CMD2, the fourth command CMD4, and the fifth command CMD5 are output to the memory device 100 more preferentially than the other commands CMD1, CMD3, and CMD6, the second command CMD2, the fourth command CMD4, and the fifth command CMD5 may be output to the memory device 100 in a sequence of the second command CMD2, the fourth command CMD4, and the fifth command CMD5. However, in another embodiment, the sequence of outputting the commands CMD2, CMD4, and CMD6 to the memory device 100 may be changed.

FIG. 8 illustrates the command scheduling operation shown in FIG. 5 in accordance with still another embodiment of the present disclosure.

Referring to FIG. 8, a plurality of commands CMDs stored in the command queue 220 before performing the command scheduling operation may be output to the memory device 100 in a sequence of a first command CMD1, a second command CMD2, a third command CMD3, a fourth command CMD4, a fifth command CMD5, and a sixth command CMD6.

An operation according to the first command CMD1 may be performed at logical addresses LBA 150 to LBA 200. An operation according to the second command CMD2 may be performed at logical addresses LBA 250 to LBA 300. An operation according to the third command CMD3 may be performed at logical addresses LBA 50 to LBA 100. An operation according to the fourth command CMD4 may be performed at logical addresses LBA 350 to LBA 400. An operation according to the fifth command CMD5 may be performed at logical addresses LBA 500 to LBA 600. An operation according to the sixth command CMD6 may be performed at logical addresses LBA 800 to LBA 900. Logical addresses at which an operation according to each command is performed are not limited to this embodiment.

A sequence of outputting the plurality of commands CMDs stored in the command queue 220 to the memory device 100 may be scheduled according to urgent processing information included in an urgent processing request URG_RQ from the host 300. The urgent processing information may include logical address information. The logical address information may include a logical address corresponding to an area of the memory device 100 in which an operation according to at least one target command is to be performed, the at least one target command being preferentially output to the memory device 100 among the plurality of commands CMDs.

For example, the command scheduling operation may be performed according to the logical address information included in the urgent processing request URG_RQ. The logical address information may include logical addresses LBA 50 to LBA 200.

The first command CMD1 and the third command CMD3, which correspond to the logical addresses LBA 50 to LBA 200, among the plurality of commands CMDs stored in the command queue 220, may be scheduled to be output to the memory device 100 more preferentially than the other commands CMD2, CMD4, CMD5, and CMD6. A sequence of outputting the commands CMD1 and CMD3 to the memory device 100 may be identical to that before the command scheduling operation is performed.

Therefore, although the first command CMD1 and the third command CMD3 are output to the memory device 100 more preferentially than the other commands CMD2, CMD4, CMD5, and CMD6, the commands CMD1 and CMD3 may be output to the memory device 100 in a sequence of the first command CMD1 and the third command CMD3. However, in another embodiment, the sequence of outputting the commands CMD1 and CMD3 may be changed.

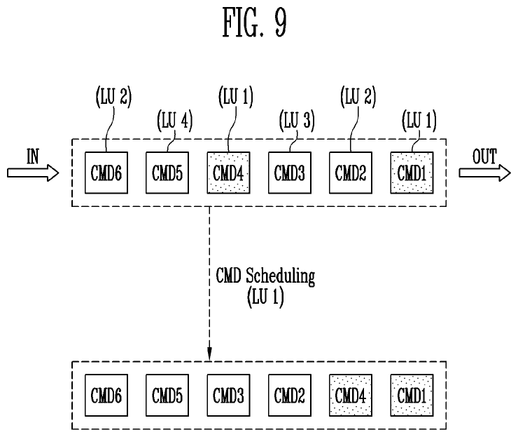

FIG. 9 illustrates the command scheduling operation shown in FIG. 5 in accordance with still another embodiment of the present disclosure.

Referring to FIG. 9, a plurality of commands CMDs stored in the command queue 220 before performing the command scheduling operation may be output to the memory device 100 in a sequence of a first command CMD1, a second command CMD2, a third command CMD3, a fourth command CMD4, a fifth command CMD5, and a sixth command CMD6.

An operation according to the first command CMD1 may be performed in a first logical unit LU1 among the plurality of logical units LU1 to LU4 described with reference to FIG. 4. An operation according to the second command CMD2 may be performed in a second logical unit LU2. An operation according to the third command CMD3 may be performed in a third logical unit LU3. An operation according to the fourth command CMD4 may be performed in the first logical unit LU1. An operation according to the fifth command CMD5 may be performed in a fourth logical unit LU4. An operation according to the sixth command CMD6 may be performed in the second logical unit LU2. A logical unit in which an operation according to each command is performed is not limited to this embodiment.

A sequence of outputting the plurality of commands CMDs stored in the command queue 220 to the memory device 100 may be scheduled based on urgent processing information included in an urgent processing request URG_RQ from the host 300. The urgent processing information may include logical address information. The logical address information may include information on a logical unit in which an operation according to at least one target command preferentially output to the memory device 100 among the plurality of commands CMDs is to be performed.

For example, the command scheduling operation may be performed according to the logical address information included in the urgent processing request URG_RQ. The logical address information may include information on the first logical unit LU1.

The first command CMD1 and the fourth command CMD4, which correspond to the first logical unit LU1, among the plurality of commands CMDs stored in the command queue 220, may be scheduled to be output to the memory device 100 more preferentially than the other commands CMD2, CMD3, CMD5, and CMD6. A sequence of outputting the commands CMD1 and CMD4 to the memory device 100 may be identical to that before the command scheduling operation is performed.

Therefore, although the first command CMD1 and the fourth command CMD4 are output to the memory device 100 more preferentially than the other commands CMD2, CMD3, CDM5, and CMD6, the commands CMD1 and CMD4 may be output in a sequence of the first command CMD1 and the fourth command CMD4. However, in another embodiment, the sequence of outputting the commands CMD1 and CMD4 may be changed.

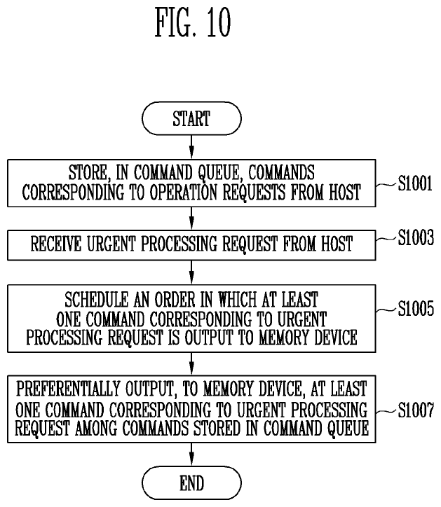

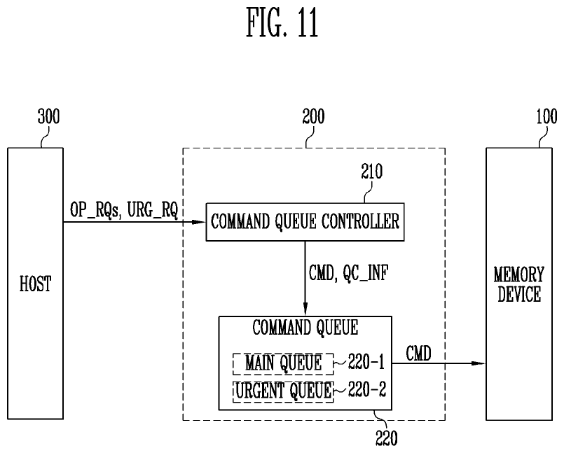

FIG. 10 is a flowchart illustrating an operation of the memory controller 200 shown in FIG. 5 in accordance with an embodiment of the present disclosure.

Referring to FIG. 10, at S1001, the memory controller 200 may store, in the command queue 220, a command CMD corresponding to an operation request OP_RQ from the host 300. When the memory controller 200 receives a plurality of operation requests OP_RQs from the host 300, the memory controller 200 may sequentially generate a plurality of commands CMDs corresponding to the plurality of operation requests OP_RQs. The memory controller 200 may store the plurality of commands CMDs in the command queue 220 in a sequence of generating the plurality of commands CMDs.

At S1003, the memory controller 200 may receive an urgent process request URG_RQ from the host 300.

At S1005, the memory controller 200 may schedule a sequence of outputting at least one target command corresponding to the urgent processing request URG_RQ to the memory device 100. Specifically, since the command queue 220 uses the FIFO scheme, the memory controller 200 may change a sequence in the command queue 220 such that the at least one target command corresponding to the urgent processing request URG_RQ, among the plurality of commands CMDs stored in the command queue 220, are output to the memory device 100 more preferentially than the other commands.

At S1007, the memory controller 200 may output, to the memory device 100, the at least one target command corresponding to the urgent processing request URG_RQ among the plurality of commands CMDs stored in the command queue 220 more preferentially than the other commands. In an embodiment, the target command may be a command corresponding to an operation request to be processed urgently among the plurality of operation requests OP_RQs.

FIG. 11 illustrates a configuration and an operation of the memory controller 200 of FIG. 1 in accordance with another embodiment of the present disclosure.

Referring to FIG. 11, the memory controller 200 may include a command queue controller 210 and a command queue 220. Unlike FIG. 5, the command queue 220 may include a main queue 220-1 and an urgent queue 220-2.

The command queue controller 210 may generate a command CMD corresponding to an operation request OP_RQ received from the host 300 in response to the operation request OP_RQ. The command queue controller 210 may store the command CMD in the main queue 220-1. The operation request OP_RQ may include any of a write request, a read request, an erase request, and an unmap request.

In an embodiment, the command queue controller 210 may sequentially generate a plurality of commands CMDs corresponding to a plurality of operation requests OP_RQs from the host 300 in response to the plurality of operation requests OP_RQs. The command queue controller 210 may store the plurality of commands CMDs in the main queue 220-1 in a sequence of generating the plurality of commands CMDs.

The command queue controller 210 may provide the main queue 220-1 and the urgent queue 220-2 with command queue control information QC_INF for controlling operations of the main queue 220-1 and the urgent queue 220-2.

In an embodiment, the command queue controller 210 may internally schedule a sequence of outputting commands stored in the main queue 220-1 to the memory device 100 according to an operational environment of the memory device 100.

In another embodiment, the command queue controller 210 may move at least one target command, among the plurality of commands CMDs stored in the main queue 220-1, to the urgent queue 220-2 in response to an urgent processing request URG_RQ provided by the host 300.

Specifically, the command queue controller 210 may select the at least one target command among the plurality of commands CMDs stored in the main queue 220-1 based on urgent processing information included in the urgent processing request URG_RQ.

The urgent processing information may include one or more of command type information, command ID information, and logical address information on the at least one target command. The command type information may indicate a type of the target command that is one of a read command, a write command, an erase command, and an unmap command. The command ID information may include a unique ID of the target command. The logical address information may include a logical address corresponding to an area in which an operation corresponding to the target command is to be performed.

The command queue controller 210 may control the main queue 220-1 and the urgent queue 220-2, such that the at least one target command stored in the urgent queue 220-2 is output to the memory device 100 more preferentially than the commands remaining in the main queue 220-1 after the at least one target command is moved to the urgent queue 220-2.

The main queue 220-1 may store the plurality of commands corresponding to the plurality of operation requests OP_RQs from the host 300. Since the main queue 220-1 basically uses the FIFO scheme, the main queue 220-1 may output the commands to the memory device 110 in a sequence in which the commands are input to the main queue 220-1. After all commands stored in the urgent queue 220-2 are output to the memory device 100, the main queue 220-1 may output the commands remaining therein to the memory device 100.

The urgent queue 220-2 may store the at least one target command to be output to the memory device 100 more preferentially than the commands stored in the main queue 220-2. The urgent queue 220-2 may store the at least one target command transferred from the main queue 220-1.

As compared with FIG. 5, the command queue 220 shown in FIG. 11 is divided into the main queue 220-1 and the urgent queue 220-2, so that an external command scheduling operation according to the urgent processing request URG_RG from the host 300 and an internal command scheduling operation according to the operational environment of the memory device 100 can be performed without collision.

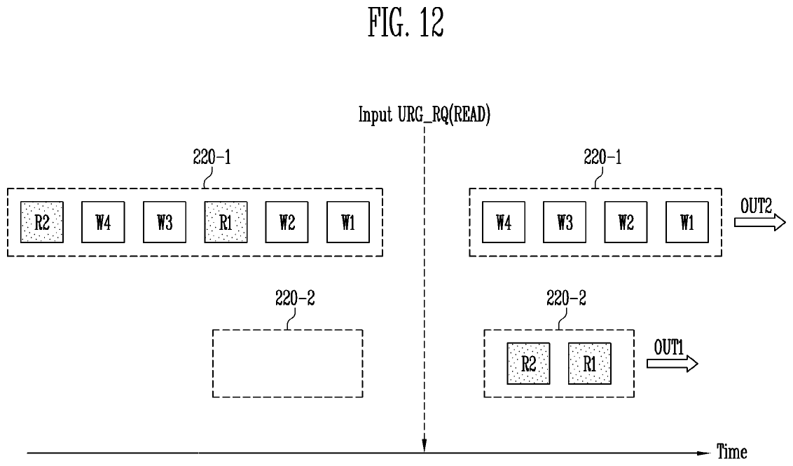

FIG. 12 illustrates a command scheduling operation shown in FIG. 11 in accordance with an embodiment of the present disclosure.

Referring to FIG. 12, before the urgent processing request URG_RQ is input to the memory controller 210, the main queue 220-1 may store a plurality of commands W1 to W4, R1, and R2. The plurality of commands W1 to W4, R1, and R2 stored in the main queue 220-1 may be output to the memory device 100 in a sequence of a first write command W1, a second write command W2, a first read command R1, a third write command W3, a fourth write command W4, and a second read command R2. At this time, the urgent queue 220-2 may have no command stored therein.

When the urgent processing request URG_RQ is input to the memory controller 210, at least one target command corresponding to the urgent processing request URG_RQ among the plurality of commands W1 to W4, R1, and R2 stored in the main queue 220-1 may be moved to the urgent queue 220-2. The urgent processing request URG_RQ may include command type information as urgent processing information. The command type information may indicate a type of a read command.

Therefore, the first read command R1 and the second read command R2 among the plurality of commands W1 to W4, R1, and R2 stored in the main queue 220-1 may be moved to the urgent queue 220-2.

The first read command R1 and the second read command R2, which are now stored in the urgent queue 220-2, may be output to the memory device 100 more preferentially than the other commands W1 to W4 remaining in the main queue 220-1 (OUT1). The commands W1 to W4 remaining in the main queue 220-1 may be output after all the commands R1 and R2 stored in the urgent queue 220-2 are output to the memory device 100 (OUT2).

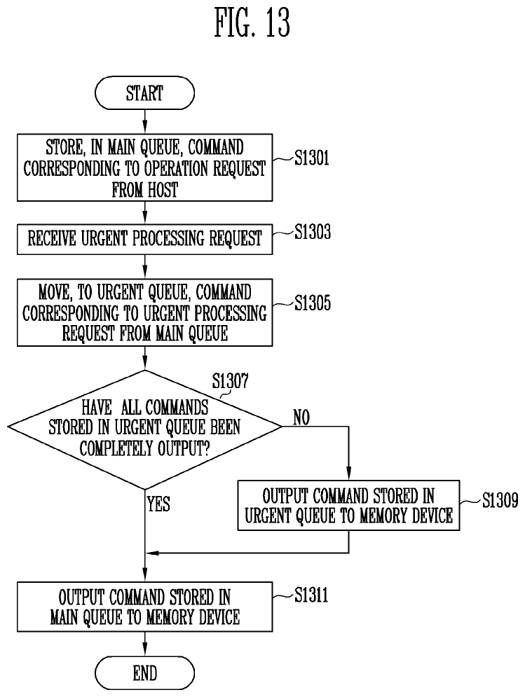

FIG. 13 is a flowchart illustrating an operation of the memory controller 200 shown in FIG. 11 in accordance with an embodiment of the present disclosure.

Referring to FIG. 13, at S1301, the memory controller 200 may store a command CMD corresponding to an operation request OP_RQ from the host 300. When the memory controller 200 receives a plurality of operation requests OP_RQs from the host 100, the memory controller 200 may sequentially generate a plurality of commands CMDs corresponding to the plurality of operation requests OP_RQs. The memory controller 200 may store the plurality of commands CMDs in the main queue 220-1 in a sequence of generating the plurality of commands CMDs.

At S1303, the memory controller 200 may receive an urgent processing request URG_RQ from the host 300.

At S1305, the memory controller 200 may move, to the urgent queue 220-2, at least one target command corresponding to the urgent processing request URG_RQ among the plurality of commands CMDs stored in the main queue 220-1.

At S1307, the memory controller 200 may determine whether all commands stored in the urgent queue 220-2 have been output to the memory device 100. As the determination result, when all the commands stored in the urgent queue 220-2 are output to the memory device 100, the memory controller 200 may proceed to S1311. When all the commands stored in the urgent queue 220-2 are not output to the memory device 100, the memory controller 200 may proceed to S1309.

At step S1309, the memory controller 200 may control the urgent queue 220-2, such that a command still remaining in the urgent queue 220-2 is output to the memory device 100.

At S1311, the memory controller 200 may control the main queue 220-1, such that commands remaining in the main queue 220-1 are output to the memory device 100.

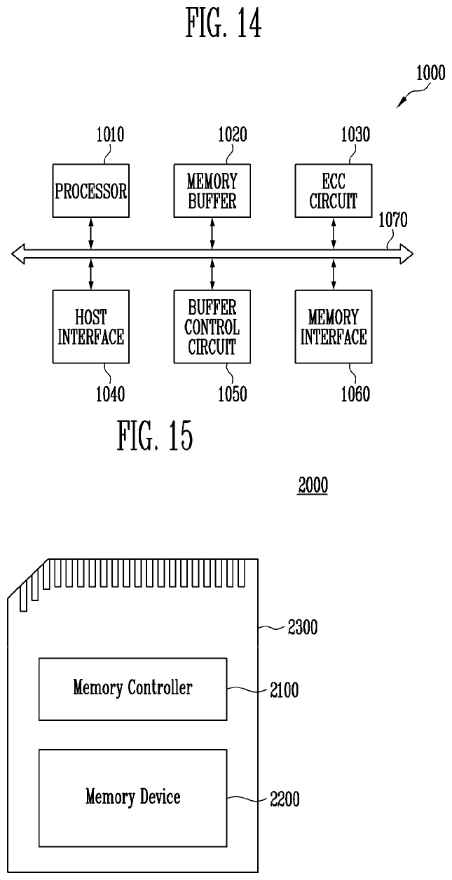

FIG. 14 illustrates a memory controller shown in FIG. 1 in accordance with an embodiment of the present disclosure.

Referring to FIG. 14, a memory controller 1000 is coupled to a host, e.g., the host 300 of FIG. 1, and a memory device, e.g., the memory device 100 of FIG. 1. The memory controller 1000 is configured to access the memory device 100 in response to a request received from the host 300. For example, the memory controller 1000 is configured to control read, program, erase, and background operations of the memory device 100. The memory controller 1000 is configured to provide an interface between the memory device 100 and the host 300. The memory controller 1000 is configured to drive firmware for controlling the memory device 100.

The memory controller 1000 may include a processor 1010, a memory buffer 1020, an error correction code (ECC) circuit 1030, a host interface 1040, a buffer control circuit 1050, a memory interface 1060, and a bus 1070.

The bus 1070 may be configured to provide channels between components of the memory controller 1000.

The processor 1010 may control overall operations of the memory controller 1000, and perform a logical operation. The processor 1010 may communicate with the external host 300 through the host interface 1040, and communicate with the memory device 100 through the memory interface 1060. Also, the processor 1010 may communicate with the memory buffer 1020 through the buffer control circuit 1050. The processor 1010 may control an operation of a storage device, e.g., the storage device 50 of FIG. 1, using the memory buffer 1020 as a working memory, a cache memory, or a buffer memory.

The processor 1010 may perform a function of a flash translation layer (FTL). The processor 1010 may translate a logical block address (LBA) provided by the host 300 through the FTL into a physical block address (PBA). The FTL may receive an LBA and translate the LBA into a PBA using a mapping table. There are several address mapping methods of the FTL according to mapping units. The address mapping methods include a page mapping method, a block mapping method, and a hybrid mapping method.

The processor 1010 is configured to randomize data received from the host 300. For example, the processor 1010 may randomize the data received from the host 300 using a randomizing seed. The randomized data is provided to the memory device 100, such that the randomized data is programmed in a memory cell array of the memory device 100.

In a read operation, the processor 1010 is configured to derandomize data received from the memory device 100. For example, the processor 1010 may derandomize the data received from the memory device 100 using a derandomizing seed. The derandomized data may be output to the host 300.

In an embodiment, the processor 1010 may perform randomizing and derandomizing by driving software or firmware.

The memory buffer 1020 may be used as the working memory, the cache memory, or the buffer memory of the processor 1010. The memory buffer 1020 may store codes and commands, which are executed by the processor 1010. The memory buffer 1020 may include a Static RAM (SRAM) or a Dynamic RAM (DRAM).

The ECC circuit 1030 may perform an ECC operation. The ECC circuit 1030 may perform ECC encoding on data to be written in the memory device 100. The ECC encoded data may be transferred to the memory device 100 through the memory interface 1060. The ECC circuit 1030 may perform ECC decoding on data received from the memory device 100 through the memory interface 1060. In an embodiment, the ECC circuit 1030 may be included as a component of the memory interface 1060 in the memory interface 1060.

The host interface 1040 may communicate with the external host 300 under the control of the processor 1010. The host interface 1040 may communicate with the host 300 using at least one of various communication protocols such as a Universal Serial bus (USB), a Serial AT Attachment (SATA), a High Speed InterChip (HSIC), a Small Computer System Interface (SCSI), Firewire, a Peripheral Component Interconnection (PCI), a PCI express (PCIe), a NonVolatile Memory Express (NVMe), a Universal Flash Storage (UFS), a Secure Digital (SD), a Multi-Media Card (MMC), an embedded MMC (eMMC), a Dual In-line Memory Module (DIMM), a Registered DIMM (RDIMM), a Load Reduced DIMM (LRDIMM), and so on.

The buffer control circuit 1050 is configured to control the memory buffer 1020 under the control of the processor 1010.

The memory interface 1060 is configured to communicate with the memory device 100 under the control of the processor 1010. The memory interface 1060 may transmit and receive at least one of a command, an address, and data to and from the memory device 100 through a channel.

In an embodiment, the memory controller 1000 may not include the memory buffer 1020 and the buffer control circuit 1050.

The processor 1010 may control an operation of the memory controller 1000 by using codes. For example, the processor 1010 may load codes from a nonvolatile memory device (e.g., a read only memory (ROM)) provided in the memory controller 1000. In another example, the processor 1010 may load codes from the memory device 100 through the memory interface 1060.

In an embodiment, the bus 1070 of the memory controller 1000 may be divided into a control bus and a data bus. The data bus may be configured to transmit data in the memory controller 1000, and the control bus may be configured to transmit control information such as a command and an address in the memory controller 1000. The data bus and the control bus are separated from each other, and may not interfere or influence with each other. The data bus may be coupled to the host interface 1040, the buffer control circuit 1050, the ECC circuit 1030, and the memory interface 1060. The control bus may be coupled to the host interface 1040, the processor 1010, the buffer control circuit 1050, the memory buffer 1020, and the memory interface 1060.

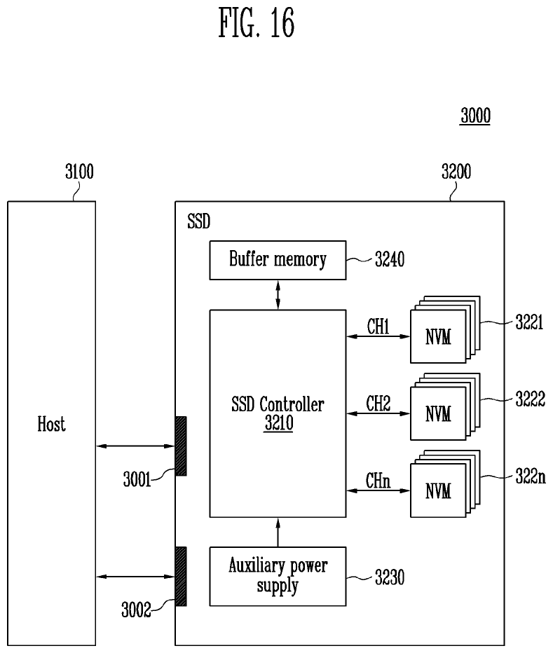

FIG. 15 illustrates a memory card system 2000 in accordance with an embodiment of the present disclosure.

Referring to FIG. 15, the memory card system 2000 includes a memory controller 2100, a memory device 2200, and a connector 2300.

The memory controller 2100 is coupled to the memory device 2200. The memory controller 2100 is configured to access the memory device 2200. For example, the memory controller 2100 is configured to control read, write, erase, and background operations of the memory device 2200. The memory controller 2100 is configured to provide an interface between the memory device 2200 and a host (not shown). The memory controller 2100 is configured to drive firmware for controlling the memory device 2200. The memory controller 2100 may be implemented with the memory controller 200 described above with reference to FIG. 1.

In an example, the memory controller 2100 may include components such as a Random Access Memory (RAM), a processing unit, a host interface, a memory interface, and an ECC circuit.

The memory controller 2100 may communicate with an external device (e.g., the host) through the connector 2300. The memory controller 2100 may communicate with the external device according to a specific communication protocol. In an example, the memory controller 2100 may communicate with the external device through at least one of various communication protocols such as a Universal Serial Bus (USB), a Multi-Media Card (MMC), an embedded MMC (eMMC), a Peripheral Component Interconnection (PCI), a PCI express (PCIe), an Advanced Technology Attachment (ATA), a Serial-ATA (SATA), a Parallel-ATA (PATA), a Small Computer System Interface (SCSI), an Enhanced Small Disk Interface (ESDI), an Integrated Drive Electronics (IDE), firewire, a Universal Flash Storage (UFS), Wi-Fi, Bluetooth, NVMe, and so on.

In an example, the memory device 2200 may be implemented with one or more of various nonvolatile memory devices such as an Electrically Erasable and Programmable ROM (EEPROM), a NAND flash memory, a NOR flash memory, a Phase-change RAM (PRAM), a Resistive RAM (ReRAM), a Ferroelectric RAM (FRAM), a Spin Torque Transfer magnetic RAM (STT-MRAM), and so on.

The memory controller 2100 and the memory device 2200 may be integrated into a single semiconductor device to constitute a memory card. For example, the memory controller 2100 and the memory device 2200 may constitute a memory card such as a PC card (Personal Computer Memory Card International Association (PCMCIA)), a Compact Flash (CF) card, a Smart Media Card (SM and SMC), a memory stick, a Multi-Media Card (MMC, RS-MMC, MMCmicro and eMMC), an SD card (SD, miniSD, microSD and SDHC), a Universal Flash Storage (UFS), or the like.

FIG. 16 illustrates a Solid State Drive (SSD) system 3000 in accordance with an embodiment of the present disclosure.

Referring to FIG. 16, the SSD system 3000 includes a host 3100 and an SSD 3200. The SSD 3200 exchanges a signal SIG with the host 3100 through a signal connector 3001, and receives power PWR through a power connector 3002. The SSD 3200 includes an SSD controller 3210, a plurality of nonvolatile memories (NVMs) 3221 to 322n, an auxiliary power supply 3230, and a buffer memory 3240. The plurality of nonvolatile memories (NVMs) 3221 to 322n may include flash memories.

In an embodiment, the SSD controller 3210 may be implemented with the memory controller 200 described above with reference to FIG. 1.

The SSD controller 3210 may control the plurality of nonvolatile memories 3221 to 322n in response to the signal SIG received from the host 3100. In an example, the signal SIG may be a signal based on an interface between the host 3100 and the SSD 3200. For example, the signal SIG may be a signal defined by at least one of communication protocols such as a Universal Serial Bus (USB), a Multi-Media Card (MMC), an embedded MMC (eMMC), a Peripheral Component Interconnection (PCI), a PCI express (PCIe), an Advanced Technology Attachment (ATA), a Serial-ATA (SATA), a Parallel-ATA (PATA), a Small Computer System Interface (SCSI), an Enhanced Small Disk Interface (ESDI), an Integrated Drive Electronics (IDE), a firewire, a Universal Flash Storage (UFS), a WI-FI, a Bluetooth, an NVMe, and so on.

The auxiliary power supply 3230 is coupled to the host 3100 through the power connector 3002. When the supply of power from the host 3100 is not smooth, the auxiliary power supply 3230 may provide power to the SSD 3200. In an example, the auxiliary power supply 3230 may be located in the SSD 3200, or be located at the outside of the SSD 3200. For example, the auxiliary power supply 3230 may be located on a main board, and provide auxiliary power to the SSD 3200.

The buffer memory 3240 operates as a buffer memory of the SSD 3200. For example, the buffer memory 3240 may temporarily store data received from the host 3100 or data received from the plurality of nonvolatile memories 3221 to 322n, or temporarily store meta data (e.g., a mapping table) of the nonvolatile memories 3221 to 322n. The buffer memory 3240 may include one or more of volatile memories, such as a DRAM, an SDRAM, a DDR SDRAM, an LPDDR SDRAM, and a GRAM, and nonvolatile memories, such as a FRAM, a ReRAM, an STT-MRAM, and a PRAM.

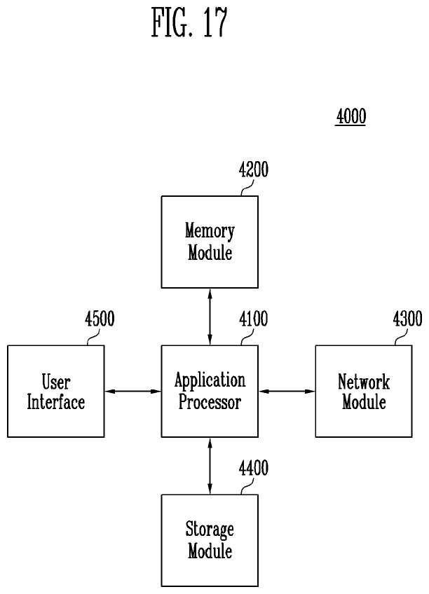

FIG. 17 illustrates a user system 4000 in accordance with an embodiment of the present disclosure.

Referring to FIG. 17, the user system 4000 includes an application processor 4100, a memory module 4200, a network module 4300, a storage module 4400, and a user interface 4500.

The application processor 4100 may drive components included in the user system 4000, an operating system (OS), a user program, and so on. In an embodiment, the application processor 4100 may include controllers for controlling components included in the user system 4000, interfaces, a graphic engine, and so on. The application processor 4100 may be provided as a System-on-Chip (SoC).

The memory module 4200 may operate as a main memory, a working memory, a buffer memory, or a cache memory of the user system 4000. The memory module 4200 may include one or more of volatile random access memories, such as a DRAM, an SDRAM, a DDR SDRAM, a DDR2 SDRM, a DDR3 SDRAM, an LPDDR SDRAM, an LPDDR2 SDRAM, and an LPDDR3 SDRAM, and nonvolatile random access memories, such as a PRAM, a ReRAM, an MRAM, and a FRAM. In an embodiment, the application processor 4100 and the memory module 4200 may be provided as one semiconductor package by being packaged based on a Package on Package (PoP).

The network module 4300 may communicate with external devices. In an embodiment, the network module 4300 may support wireless communications such as Code Division Multiple Access (CDMA), Global System for Mobile communication (GSM), Wideband CDMA (WCDMA), CDMA-2000, Time Division Multiple Access (TDMA), Long Term Evolution (LTE), Wimax, WLAN, UWB, Bluetooth, and Wi-Fi. In an embodiment, the network module 4300 may be included in the application processor 4100.

The storage module 4400 may store data. For example, the storage module 4400 may store data received from the application processor 4100. Alternatively, the storage module 4400 may transmit data stored therein to the application processor 4100. In an embodiment, the storage module 4400 may be implemented with a nonvolatile semiconductor memory device such as a Phase-change RAM (PRAM), a Magnetic RAM (MRAM), a Resistive RAM (RRAM), a NAND flash, a NOR flash, or a NAND flash having a three-dimensional structure. In an embodiment, the storage module 4400 may be provided as a removable drive such as a memory card or an external drive.

In an embodiment, the storage module 4400 may include a plurality of nonvolatile memory devices, and the plurality of nonvolatile memory devices may operate like the memory device 100 described above with reference to FIG. 1. The storage module 4400 may operate like the storage device 50 described above with reference to FIG. 1.

The user interface 4500 may include interfaces for inputting data or commands to the application processor 4100 or outputting data to an external device. In an embodiment, the user interface 4500 may include one or more of user input interfaces such as a keyboard, a keypad, a button, a touch panel, a touch screen, a touch pad, a touch ball, a camera, a microphone, a gyroscope sensor, a vibration sensor, a piezoelectric element, and so on. The user interface 4500 may further include one or more of user output interfaces such as a Liquid Crystal Display (LCD), an Organic Light Emitting Diode (OLED) display device, an Active Matrix OLED (AMOLED) display device, an LED, a speaker, a monitor, and so on.

In accordance with the embodiments of the present disclosure, a storage device and an operating method thereof may have improved command scheduling performance.

What is claimed is:

1. A memory controller, comprising:
a command queue configured to store a plurality of commands corresponding to a plurality of operation requests provided by a host, and output the plurality of commands to a memory device; and
a command queue controller configured to control the command queue to preferentially output, to the memory device, one or more target commands, which correspond to an urgent processing request provided by the host, among the plurality of commands, in response to the urgent processing request.

2. The memory controller of claim 1, wherein the command queue controller selects the one or more target commands among the plurality of commands based on urgent processing information included in the urgent processing request.

3. The memory controller of claim 2, wherein the urgent processing information includes one or more of command type information, command ID information, and logical address information on the one or more target commands.

4. The memory controller of claim 3, wherein the command type information indicates a type of one of a read command, a write command, an erase command, and an unmap command.

5. The memory controller of claim 3, wherein the logical address information includes a logical address corresponding to an area in which an operation corresponding to each of the one or more target commands is to be performed.

6. A method of operating a memory controller including a command queue, the method comprising:
storing, in the command queue, a plurality of commands corresponding to a plurality of operation requests provided by a host;
receiving an urgent processing request from the host; and
scheduling a sequence of outputting one or more target commands corresponding to the urgent processing request among the plurality of commands to a memory device.

7. The method of claim 6, further comprising outputting the one or more target commands more preferentially than the other commands, among the plurality of commands.

8. The method of claim 7, further comprising selecting the one or more target commands among the plurality of commands based on urgent processing information included in the urgent processing request.

9. The method of claim 8, wherein the urgent processing information includes one or more of command type information, command ID information, and logical address information on the one or more target commands.

10. The method of claim 9, wherein the command type information indicates a type of one of a read command, a write command, an erase command, and an unmap command.

11. The method of claim 9, wherein the logical address information includes a logical address corresponding to an area in which an operation corresponding to each of the one or more target commands is to be performed.

12. A memory controller, comprising:
a main queue configured to store a plurality of commands corresponding to a plurality of operation requests provided by a host;
an urgent queue configured to store one or more target commands to be output to a memory device more preferentially than commands remaining in the main queue; and
a command queue controller configured to move, to the urgent queue, the one or more target commands among the plurality of commands stored in the main queue in response to an urgent processing request provided by the host.

13. The memory controller of claim 12, wherein the command queue controller controls the urgent queue to output the one or more target commands stored in the urgent queue to the memory device.

14. The memory controller of claim 13, wherein the command queue controller controls the main queue to output the commands remaining in the main queue to the memory device after all of the one or more target commands stored in the urgent queue are output to the memory device.

15. The memory controller of claim 12, wherein the command queue controller schedules a sequence of outputting the commands remaining in the main queue to the memory device according to an operational environment of the memory device.

16. The memory controller of claim 12, wherein the command queue controller selects the one or more target commands among the plurality of commands based on urgent processing information included in the urgent processing request.

17. The memory controller of claim 16, wherein the urgent processing information includes one or more of command type information, command ID information, and logical address information on the one or more target commands.

18. The memory controller of claim 17, wherein the command type information indicates a type of one of a read command, a write command, an erase command, and an unmap command.

19. The memory controller of claim 17, wherein the logical address information includes a logical address corresponding to an area in which an operation corresponding to each of the one or more target commands is to be performed.
